(19) United States
(12) Patent Application Publication
(10) Pub. No.: US 2025/0390724 A1
(43) Pub. Date: Dec. 25, 2025

(54) QUANTIZATION PARAMETER STORAGE METHOD, MODEL INFERENCE METHOD, ELECTRONIC DEVICE AND STORAGE MEDIUM

(71) Applicant: Beijing Baidu Netcom Science Technology Co., Ltd., Beijing (CN)

(72) Inventors: Minghao LI, Beijing (CN); Handi ZHANG, Beijing (CN); Zhaojing ZHOU, Beijing (CN); Haoshuang WANG, Beijing (CN); Qingqing DANG, Beijing (CN); Yanlin SHA, Beijing (CN); Dianhai YU, Beijing (CN); Yanjun MA, Beijing (CN)

(21) Appl. No.: 19/022,349

(22) Filed: Jan. 15, 2025

(30) Foreign Application Priority Data
Jun. 20, 2024 (CN) 202410805209.9

(51) Int. Cl. G06N 3/0495

(52) U.S. Cl. CPC G06N 3/0495

(57) ABSTRACT

Provided is a quantization parameter storage method, a model inference method, an electronic device and a storage medium, relating to the fields of large model technology, artificial intelligence technology and model quantization technology. The quantization parameter storage method includes: obtaining, by a calculation unit of a processor, a statistical value of a first quantization parameter of a model statistically based on benchmark data; searching for, by the calculation unit, a target value of the first quantization parameter and a target value of a second quantization parameter of the model in a search space based on the statistical value of the first quantization parameter; and storing, by the calculation unit, the target value of the first quantization parameter and the target value of the second quantization parameter into a memory.

### CROSS-REFERENCE TO RELATED APPLICATIONS

The present application claims priority to Chinese Patent Application No. CN202410805209.9, filed with the China National Intellectual Property Administration on Jun. 20, 2024, the disclosure of which is hereby incorporated herein by reference in its entirety.

### TECHNICAL FIELD

The present disclosure relates to the field of computer technology, and in particular to the fields of large model technology, artificial intelligence technology, and model quantization technology.

### BACKGROUND

The cost of model inference increases significantly with the increase in the number of model parameters and context. Large models have a huge number of parameters and context. For example, some large models have tens of billions of parameters, and some large models have context with millions of words. The low-bit quantization can reduce the usage of the video memory of the Graphics Processing Unit (GPU) and reduce the cost of large model deployment.

### SUMMARY

The present disclosure provides a quantization parameter storage method, a model inference method, a device and a storage medium.

According to an aspect of the present disclosure, provided is a quantization parameter storage method, including:
obtaining, by a calculation unit of a processor, a statistical value of a first quantization parameter of a model statistically based on benchmark data;
searching for, by the calculation unit, a target value of the first quantization parameter and a target value of a second quantization parameter of the model in a search space based on the statistical value of the first quantization parameter; and
storing, by the calculation unit, the target value of the first quantization parameter and the target value of the second quantization parameter into a memory.

According to another aspect of the present disclosure, provided is a model inference method, including:
processing, by a calculation unit of a processor, input data of a model to obtain a key value matrix in a first format;
reading, by the calculation unit, a target value of a first quantization parameter and a target value of a second quantization parameter from a memory, where the target value of the first quantization parameter and the target value of the second quantization parameter are stored into the memory before a model inference process by using the method in any embodiment described above;
quantizing, by the calculation unit, the key value matrix in the first format to obtain a key value matrix in a second format based on a quantization function constructed by the target value of the first quantization parameter and the target value of the second quantization parameter; and
storing, by the calculation unit, the key value matrix in the second format into a key value cache of the processor.

According to another aspect of the present disclosure, provided is a quantization parameter storage apparatus, including:
a statistical module configured to obtain, by a calculation unit of a processor, a statistical value of a first quantization parameter of a model statistically based on benchmark data;
a search module configured to search for, by the calculation unit, a target value of the first quantization parameter and a target value of a second quantization parameter of the model in a search space based on the statistical value of the first quantization parameter; and
a calculation module configured to store, by the calculation unit, the target value of the first quantization parameter and the target value of the second quantization parameter into a memory.

According to another aspect of the present disclosure, provided is a model inference apparatus, including:
a processing module configured to process, by a calculation unit of a processor, input data of a model to obtain a key value matrix in a first format;
a first reading module configured to read, by the calculation unit, a target value of a first quantization parameter and a target value of a second quantization parameter from a memory, where the target value of the first quantization parameter and the target value of the second quantization parameter are stored into the memory before a model inference process by using the apparatus in any embodiment described above;
a quantization module configured to quantize, by the calculation unit, the key value matrix in the first format to obtain a key value matrix in a second format based on a quantization function constructed by the target value of the first quantization parameter and the target value of the second quantization parameter; and a storage module configured to store, by the calculation unit, the key value matrix in the second format into a key value cache of the processor.

According to yet another aspect of the present disclosure, provided is an electronic device, including:
at least one processor; and a memory connected in communication with the at least one processor;
where the memory stores an instruction executable by the at least one processor, and the instruction, when executed by the at least one processor, enables the at least one processor to execute the method of any embodiment of the present disclosure.

According to yet another aspect of the present disclosure, provided is a non-transitory computer-readable storage medium storing a computer instruction thereon, and the computer instruction is used to cause a computer to execute the method of any embodiment of the present disclosure.

According to yet another aspect of the present disclosure, provided is a computer program product including a computer program, and the computer program implements the method of any embodiment of the present disclosure, when executed by a processor.

According to the present disclosure, since the quantization parameters can be calculated and stored in advance, then the quantization parameters that have been calculated in advance can be read according to specific usage requirements for quantitative inference in the inference process, thus reducing the occupancy of the memory of the processor. Since there is no need to repeatedly calculate the quantization parameters in the inference process, the computing resources required for the inference process can be reduced, and the inference speed and efficiency can be improved.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a structural schematic diagram of a large language model according to an embodiment of the present disclosure;

FIG. 2 is a structural schematic diagram of a multi-head attention layer according to an embodiment of the present disclosure;

FIG. 3 is a schematic flow chart of a quantization parameter storage method according to an embodiment of the present disclosure;

FIG. 4 is a schematic flow chart of a quantization parameter storage method according to another embodiment of the present disclosure;

FIG. 5 is a schematic flow chart of a quantization parameter storage method according to another embodiment of the present disclosure;

FIG. 6 is a schematic flow chart of a quantization parameter storage method according to another embodiment of the present disclosure;

FIG. 7 is a schematic flow chart of a quantization parameter storage method according to another embodiment of the present disclosure;

FIG. 8 is a schematic flow chart of a model inference method according to an embodiment of the present disclosure;

FIG. 9 is a schematic flow chart of a model inference method according to another embodiment of the present disclosure;

FIG. 10 is a schematic diagram of an application scenario of ABQ according to an embodiment of the present disclosure;

FIG. 11 is a structural schematic diagram of a quantization parameter storage apparatus according to an embodiment of the present disclosure;

FIG. 12 is a structural schematic diagram of a quantization parameter storage apparatus according to another embodiment of the present disclosure;

FIG. 13 is a structural schematic diagram of a model inference apparatus according to an embodiment of the present disclosure;

FIG. 14 is a structural schematic diagram of a model inference apparatus according to another embodiment of the present disclosure; and

FIG. 15 is a block diagram of an electronic device for implementing the methods of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

Large models are being used in an endless stream around the world. For example, some large models can solve problems in conversation, logical thinking, code generation, knowledge question and answer, and other aspects. Some large models have been applied and landed in various scenarios in the Chinese field. Some large models have up to 70 billion parameters, and some large models are generated in the context with 2 million words. For example, a model with 70 billion parameters requires 140 GB of video memory space of GPU during inference. If the context with 2 million words (about 400 GB) is added, more than 500 GB of video memory will be required. Considering that some GPUs have single-card video memory of 80 GB, 8 cards are needed to meet the demand without any optimization, and only one user can be supported at the same time. The inference cost is very high.

The low-bit Key Value Cache (KV Cache) (hereinafter referred to as C4, C2) quantization may include dynamic quantization, hybrid quantization, etc., but the above quantization methods have some problems. For example, in the dynamic C4 quantization scheme, the information such as quantization scale factor (scale) must be calculated for each decoding process of each query statement (query), to ensure the quantization accuracy. Since it is necessary to repeatedly count and quantify scale and other information during the inference process, the additional inference overhead is produced, which does not meet the actual landing requirements. For another example, the mixed bit quantization of C4 and C8 requires modification of model networking and other operations to ensure the inference effect. For another example, some non-quantitative inference methods may also bring additional time consumption for inference. For example, the prompt compression requires a small front-end model for compression while the front-end model requires inference time; and the token eviction needs to be combined with a specific eviction strategy and calculated in combination with the token.

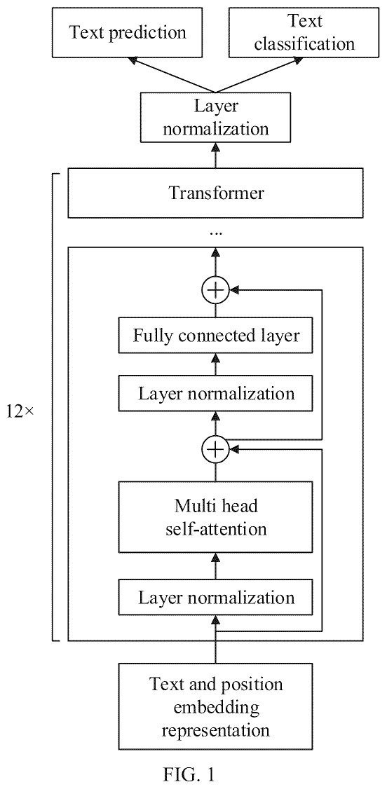

FIG. 1 is a schematic diagram of a model structure. The solution based on the embodiments of the present disclosure can provide a low-cost inference deployment solution for Large Language Models (LLMs). The LLM is used to solve common natural language tasks, including semantic understanding, multi-round conversation, logical thinking, code writing, text creation and other capabilities. The model structure is composed by stacking several transformer layers, and each layer has models such as layer normalization (LayerNorm), multi head attention, and fully connected layer (FeedForward). After the input text is processed by the text and position embedding representation layer, a text vector or a text tensor or other features may be obtained.

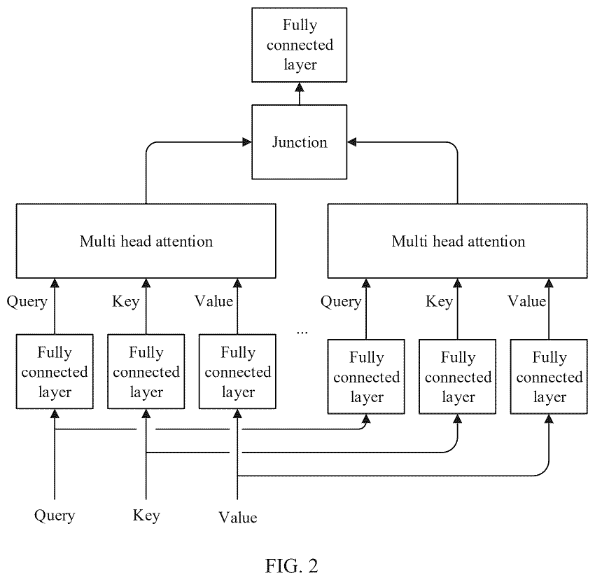

In order to reduce the cost during inference (after training), the multi head attention module in the above model structure needs to store the KV cache information. When the input information of the model is very long (for example, a scenario with 2 million words as input), the video memory and computing power occupied are very large, and the inference cost of the large model is high. As shown in FIG. 2, in the architecture of the multi head attention module, the numerical values of Key (K) and Value (V) need to be stored during the actual inference process. Due to the need for repeated storage, reading and other operations, the computing bandwidth and

GPU video memory required are very large. For example, the Scaled Dot-Product Attention module may perform a matrix multiplication (MatMul) operation, a scale operation, a mask operation, a softmax operation and other operations on the query (Q) matrix and the key (K), and then perform a matrix multiplication (MatMul) operation on the calculation result and the value (V) matrix.

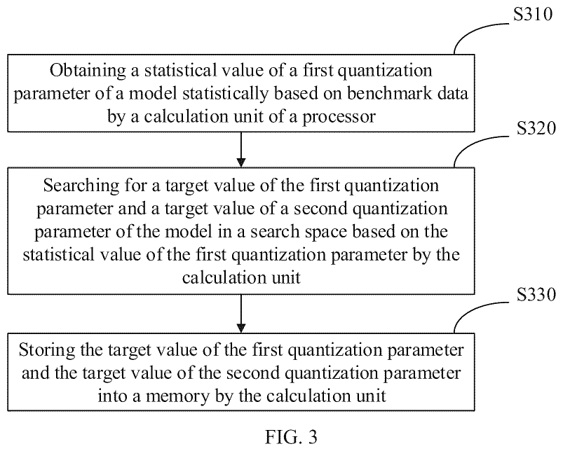

FIG. 3 is a schematic flow chart of a quantization parameter storage method according to an embodiment of the present disclosure. The method may include:
S310: obtaining a statistical value of a first quantization parameter of a model statistically based on benchmark data by a calculation unit of a processor;
S320: searching for a target value of the first quantization parameter and a target value of a second quantization parameter of the model in a search space based on the statistical value of the first quantization parameter by the calculation unit; and
S330: storing the target value of the first quantization parameter and the target value of the second quantization parameter into a memory by the calculation unit.

In the embodiment of the present disclosure, the processor may be a Graphics Processing Unit (GPU), a Central Processing Unit (CPU), or a Neural Processing Unit (NPU) (or called a neural network processing unit), etc. The processor may include a calculation unit, a memory, a cache, etc. For example, the calculation unit in the GPU may include a Stream Multiprocessor (SM), and the memory may also be referred to as video memory.

In the embodiment of the present disclosure, the occupancy of the cache of the processor can be reduced through quantization in the process of performing model inference on the trained model. There are many kinds of quantization parameters that need to be used in the process of model inference, such as quantization scale factor (scale), quantization zero point (zero_point), etc. If the dynamic quantization solution is adopted, the quantization parameters need to be repeatedly counted during the inference process, and more computing resources are required. The embodiment of the present disclosure may adopt a static quantization solution, in which the quantization parameters required for inference may be calculated in advance, and these quantization parameters are stored into the memory such as a hard disk.

In the embodiment of the present disclosure, the statistical value of the quantization parameter of the model may be counted based on the benchmark data. The benchmark data may be extracted from the training samples of the model. For example, the benchmark data may include text information. Referring to FIG. 1, after the benchmark data is input into the model, the benchmark data may be firstly embedded and encoded to obtain a benchmark feature, such as a benchmark vector or a benchmark tensor, etc.

In the embodiment of the present disclosure, the model may have an attention layer such as a self-attention layer, a multi-head self-attention layer, etc. Some statistical rules may be set in the attention layer. Referring to FIG. 1, after the calculation unit processes the benchmark feature through a normalization layer and others, the benchmark feature may be input into the attention layer. At the attention layer, the received features may be counted according to a statistical rule to obtain the statistical value of the quantization parameter. The statistical rule may include statistical average, statistical maximum of absolute maximum, etc. The rule based on statistical average can count the average of multiple pieces of benchmark data, and the rule based on statistical maximum of absolute maximum can count the maximum of the absolute maximum of multiple pieces of benchmark data. Then the statistical value of the first quantization parameter of the model may be calculated based on the statistical result. The statistical value of the first quantization parameter may be stored in the cache or memory. Also, the pre-stored search space may be read from the memory, and the target value of the first quantization parameter and the target value of the second quantization parameter of the model may be obtained based on the search value in the search space and the statistical value of the first quantization parameter. In the embodiment of the present disclosure, the first quantization parameter may be a quantization scale factor (scale), and the second quantization parameter may be a quantization zero point (zero_point). The calculation unit may save the target value of the first quantization parameter and the target value of the second quantization parameter into the memory such as a hard disk.

In the embodiment of the present disclosure, since the quantization parameters can be calculated and stored in advance, then the quantization parameters that have been calculated in advance can be read according to specific usage requirements for quantitative inference in the inference process, thus reducing the occupancy of the memory of the processor. Since there is no need to repeatedly calculate the quantization parameters in the inference process, the computing resources required for the inference process can be reduced, and the inference speed and efficiency can be improved.

In one implementation, the target value of the first quantization parameter and the target value of the second quantization parameter can be read from the memory to the processor during model inference, and used to quantize a key value matrix in a first format required by an attention layer of the model into a key value matrix in a second format; where the key value matrix in the second format is stored in a key value cache of the processor.

In the embodiment of the present disclosure, the processor may read the required quantization parameters from the memory according to the quantization requirement of each layer of the model in the model inference process. For example, if the Key Value (KV) matrix of the attention layer of the model needs to be quantized, the target value of the first quantization parameter such as quantization scale factor and the target value of the second quantization parameter such as quantization zero point may be read from the memory to quantize the key value matrix required for the attention layer. For example, before quantization, the first format of the key value matrix required for the attention layer is Brain Floating Point 16 (BF16) format. After quantization, the second format of the key value matrix required for the attention layer is 4-bit integer (INT4) format. The INT4 format takes up less storage space than the BF16 format. The key value matrix required for the attention layer may be stored in the KV cache of the processor after quantization. Since the KV matrix after quantization occupies less storage space than the KV matrix before quantization and the key value cache is usually in the memory of the processor, the occupancy of the memory of the processor, such as the video memory of the GPU, can be reduced. Since the KV matrix can be quantized using the quantization parameters calculated and stored in advance without a need to calculate the quantization parameters before quantization, the computing resources required for the quantization process of inference can be reduced, and the inference speed and efficiency can be improved.

In one implementation, the target value of the first quantization parameter and the target value of the second quantization parameter can be read from the memory to the processor during model inference, and used to dequantize the key value matrix in the second format read from the key value cache into the key value matrix in the first format; where the dequantized key value matrix is used as an input feature of the attention layer.

For example, if the KV matrix in the second format in the KV cache needs to be dequantized, the processor may read the target value of the first quantization parameter such as quantization scale factor and the target value of the second quantization parameter such as quantization zero point from the memory, to dequantize the key value matrix required for the attention layer. The first quantization parameter may also be an dequantization scale factor, or the dequantization scale factor may be derived from the quantization scale factor. For example, the key value matrix in the second format may be dequantized into the key value matrix in the first format through dequantization. After dequantization, the accuracy of the key value matrix of the attention layer of the input model can be improved. Since the quantized KV matrix in the memory can be dequantized using the quantization parameters calculated and stored in advance, and since there is no need to calculate the quantization parameters before dequantization, the computing resources required for the dequantization process of inference can be reduced, and the inference speed and efficiency can be improved.

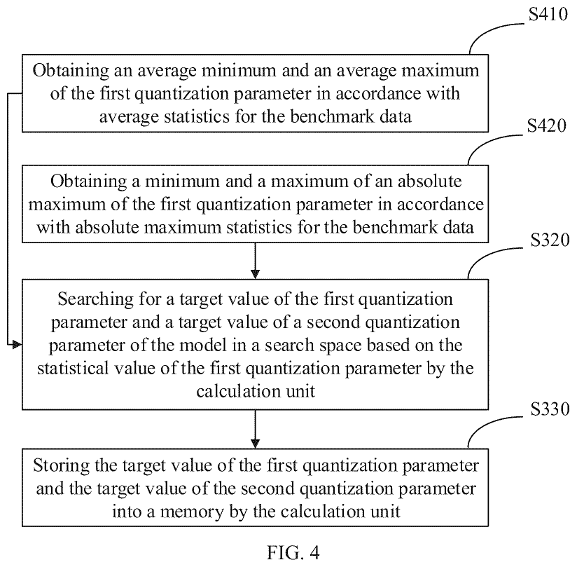

FIG. 4 is a schematic flow chart of a quantization parameter storage method according to another embodiment of the present disclosure. This embodiment may include one or more features of the above-described embodiments. In one implementation, the step of obtaining a statistical value of a first quantization parameter of a model statistically based on benchmark data by a calculation unit of a processor, includes at least one of:
S410: obtaining an average minimum and an average maximum of the first quantization parameter in accordance with average statistics for the benchmark data; and
S420: obtaining a minimum and a maximum of an absolute maximum of the first quantization parameter in accordance with absolute maximum statistics for the benchmark data.

In the embodiment of the present disclosure, the timing of S410 and S420 is not limited. S410 may be executed first and then S420, or S420 may be executed first and then S410, or only one of the steps may be executed.

For example, if a piece of benchmark data corresponds to a group of features, the average and the maximum of the absolute maximum of the group of features may be calculated firstly. Using the rule of the statistical average, the average minimum and the average maximum may be statistically obtained from the averages corresponding to N pieces of benchmark data. Using the rule of the statistical maximum of the absolute maximum, the minimum and the maximum of the absolute maximum may be statistically obtained from the absolute maximums corresponding to N pieces of benchmark data. The target value of the first quantization parameter may be searched more accurately based on one or more of the average minimum, the minimum of the absolute maximum, the average maximum, and the maximum of the absolute maximum.

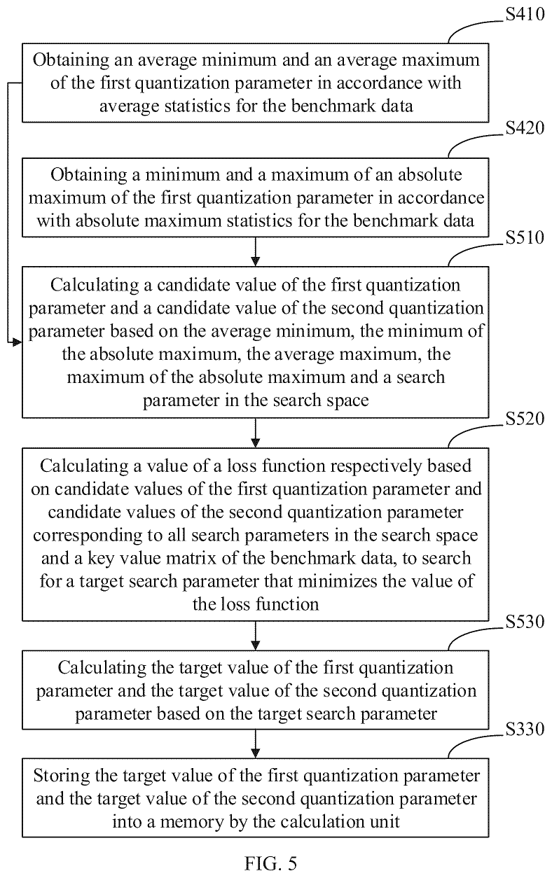

FIG. 5 is a schematic flow chart of a quantization parameter storage method according to another embodiment of the present disclosure. This embodiment may include one or more features of the above-described embodiments. In one implementation, the step of searching for a target value of the first quantization parameter and a target value of a second quantization parameter of the model in a search space based on the statistical value of the first quantization parameter, includes:
S510: calculating a candidate value of the first quantization parameter and a candidate value of the second quantization parameter based on the average minimum, the minimum of the absolute maximum, the average maximum, the maximum of the absolute maximum and a search parameter in the search space;
S520: calculating a value of a loss function respectively based on candidate values of the first quantization parameter and candidate values of the second quantization parameter corresponding to all search parameters in the search space and a key value matrix of the benchmark data, to search for a target search parameter that minimizes the value of the loss function; and
S530: calculating the target value of the first quantization parameter and the target value of the second quantization parameter based on the target search parameter.

In the embodiment of the present disclosure, the search parameters may include a plurality of search values. One or more search spaces may be preset in the memory of the processor. The calculation unit may read the search value of the search space from the memory for subsequent calculation. For example, the search space is S=[0, 0.2, 0.4, 0.6]. The calculation unit may use the same search parameter when calculating the candidate value of the first quantization parameter and the candidate value of the second quantization parameter. For example, a search parameter s, such as 0.2, may be selected from the search space S and substituted into the quantization parameter related formula to calculate the candidate value of the first quantization parameter and the candidate value of the second quantization parameter. Then, the candidate value of the first quantization parameter and the candidate value of the second quantization parameter are substituted into the formula of the loss function to calculate the loss value corresponding to s. The loss values corresponding to all values of s in the search space are compared to obtain so with the least loss value as the target search parameter. Then the target search parameter so is substituted into the quantization parameter related formula to calculate the target value of the first quantization parameter and the target value of the second quantization parameter.

In the embodiment of the present disclosure, the target value of the quantization parameter can be quickly searched based on the search space, improving the calculation speed and efficiency. Also, the search parameters in the search space can be optimized according to the search process. For example, if the loss value corresponding to the search parameter is relatively large, such as greater than a threshold, the search parameter may be deleted. For another example, if the larger search parameter corresponds to the larger loss value, more search parameters with smaller values may be added. For another example, if the larger search parameter corresponds to the smaller loss value, more search parameters with larger values may be added. The optimization of the search space is conducive to further improving the search speed and efficiency.

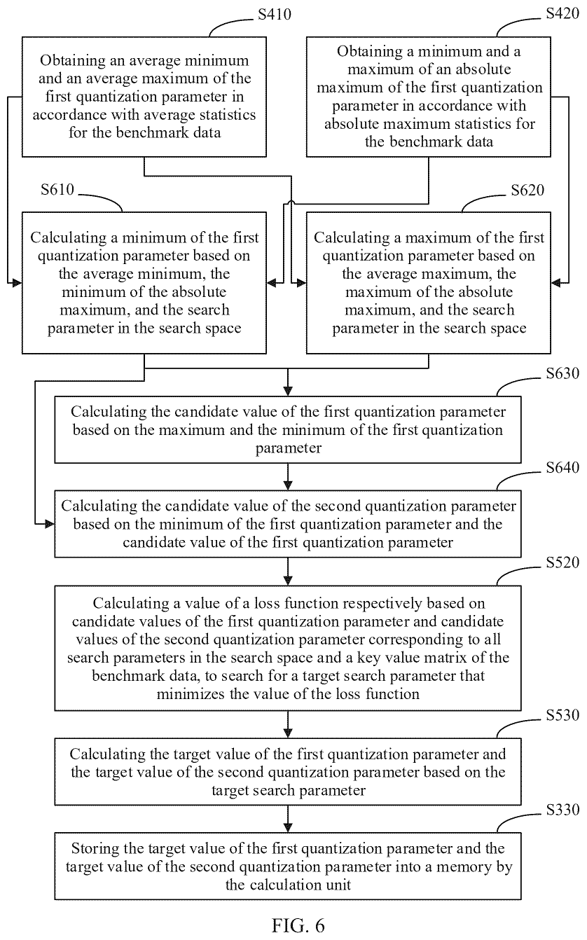

FIG. 6 is a schematic flow chart of a quantization parameter storage method according to another embodiment of the present disclosure. This embodiment may include one or more features of the above-described embodiments. In one implementation, the step of calculating a candidate value of the first quantization parameter and a candidate value of the second quantization parameter based on the average minimum, the minimum of the absolute maximum, the average maximum, the maximum of the absolute maximum and a search parameter in the search space, includes:
S610: calculating a minimum of the first quantization parameter based on the average minimum, the minimum of the absolute maximum, and the search parameter in the search space;
S620: calculating a maximum of the first quantization parameter based on the average maximum, the maximum of the absolute maximum, and the search parameter in the search space;
S630: calculating the candidate value of the first quantization parameter based on the maximum and the minimum of the first quantization parameter; and
S640: calculating the candidate value of the second quantization parameter based on the minimum of the first quantization parameter and the candidate value of the first quantization parameter.

An example of a formula for the minimum of the first quantization parameter is as follows:

$$scale\_min = s * avg\_min + ( 1 - s ) * abs max\_min \qquad Formula 1$$

Here, scale_min may represent the minimum of the first quantization parameter, avg_min may represent the average minimum, absmax_min may represent the minimum of the absolute maximum, avg may represent the average after feature normalization, and absmax may represent the absolute maximum after feature normalization. The minimum average (that is, avg_min) may be obtained by counting avg of multiple pieces of benchmark data; and the minimum absolute maximum (that is, absmax_min) may be obtained by counting absmax of multiple pieces of benchmark data. s may represent a search parameter in the search space S, and s belongs to S.

An example of a formula for the maximum of the first quantization parameter is as follows:

$$scale\_max = s * avg\_max + ( 1 - s ) * abs max\_max \qquad Formula 2$$

Here, scale_max may represent the maximum of the first quantization parameter, avg_max may represent the average maximum, and absmax_max may represent the maximum of the absolute maximum. The maximum average (that is, avg_max) may be obtained by counting avg of multiple pieces of benchmark data; and the maximum absolute maximum (that is, absmax_max) may be obtained by counting absmax of multiple pieces of benchmark data. The meaning of s is the same as that in Formula 1, and the search parameters of Formula 1 and Formula 2 may take the same value.

An example of a formula for the candidate value of the first quantization parameter is as follows:

$$scale = \frac{scale\_max - scale\_min}{15} \qquad Formula 3$$

Here, the meanings of scale_max and scale_min refer to Formula 1 and Formula 2, and scale_max and scale_min can be calculated by Formula 1 and Formula 2. The present disclosure does not limit the calculation order of Formula 1 and Formula 2. scale may represent the candidate value of the first quantization parameter. The candidate values of multiple first quantization parameters corresponding to multiple search parameters may be calculated according to Formula 3.

An example of a formula for the candidate value of the second quantization parameter is as follows:

$$zero\_point = clip ( - 8 - round ( \frac{scale\_min}{scale} ) , - 8 , 7 ) \qquad Formula 4$$

Here, scale_min may be obtained by Formula 1, and the meaning of scale refers to Formula 3. round( ) is the rounding operation, and clip( ) is to obtain a value that does not exceed the upper and lower boundaries from values in the brackets, where the second element in the brackets represents the lower boundary, and the third element represents the upper boundary. That is, when the value of the first element does not exceed the upper and lower boundaries, the value of the first element is taken as the calculation result; when the value of the first element is less than the lower boundary, the value of the lower boundary (the second element) is taken as the calculation result; when the value of the first element is greater than the upper boundary, the value of the upper boundary (the third element) is taken as the calculation result.

For example, the above-mentioned average minimum avg_min and minimum of absolute maximum absmax_min obtained statistically as well as a search parameter s selected in the search space are substituted into the above Formula 1, to calculate the minimum scale_min of the quantization scale factor. The above-mentioned average maximum avg_max and maximum of absolute maximum absmax_max obtained statistically as well as a search parameter s selected in the search space are substituted into the above Formula 2, to calculate the maximum scale_max of the quantization scale factor. scale_min and scale_max are substituted into the Formula 3 for the candidate value of the first quantization parameter, to obtain the candidate value scale of the first quantization parameter. Then, scale_min and scale are substituted into the Formula 4 for the candidate value of the second quantization parameter, to obtain the candidate value zero_point of the second quantization parameter.

In the embodiment of the present disclosure, the candidate values of the quantization parameters calculated based on multiple statistical values of the quantization parameters are more accurate. Using the same search parameter in the same search space can increase the search speed.

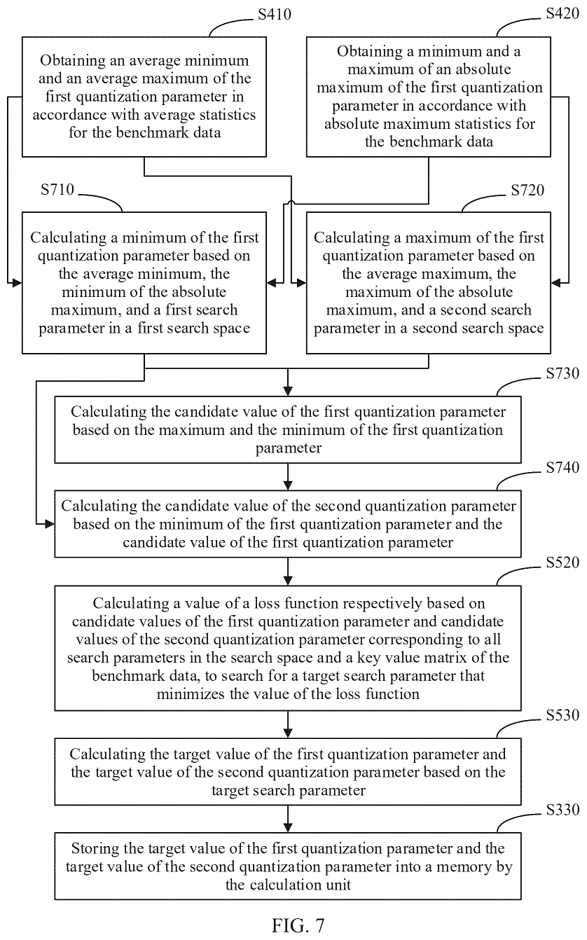

FIG. 7 is a schematic flow chart of a quantization parameter storage method according to another embodiment of the present disclosure. This embodiment may include one or more features of the above-described embodiments. In one implementation, the step of calculating a candidate value of the first quantization parameter and a candidate value of the second quantization parameter based on the average minimum, the minimum of the absolute maximum, the average maximum, the maximum of the absolute maximum and a search parameter in the search space, includes:
S710: calculating a minimum of the first quantization parameter based on the average minimum, the minimum of the absolute maximum, and a first search parameter in a first search space;
S720: calculating a maximum of the first quantization parameter based on the average maximum, the maximum of the absolute maximum, and a second search parameter in a second search space;
S730: calculating the candidate value of the first quantization parameter based on the maximum and the minimum of the first quantization parameter; and
S740: calculating the candidate value of the second quantization parameter based on the minimum of the first quantization parameter and the candidate value of the first quantization parameter.

An example of a formula for the minimum of the first quantization parameter is as follows:

$$scale\_min = {s}_{1} * avg\_min + ( 1 - {s}_{1} ) * abs max\_min \qquad Formula 5$$

Here, the meanings of scale_min, avg_min and absmax_min can refer to Formula 1 and will not be repeated here. s₁ is the first search parameter belonging to the first search space S₁.

An example of a formula for the maximum of the first quantization parameter is as follows:

$$scale\_max = {s}_{2} * avg\_max + ( 1 - {s}_{2} ) * abs max\_max \qquad Formula 6$$

Here, the meanings of scale_max, avg_max and absmax_max are the same as those in Formula 2 and will not be repeated here. s₂ is the second search parameter belonging to the second search space S₂.

In the embodiment of the present disclosure, s₁ and s₂ may be different search parameters in different search spaces respectively. In one implementation, s₁ and s₂ may also be different search parameters in the same search space. In this case, the first search space and the second search space may be understood as the same search space.

After scale_min and scale_max are calculated based on Formula 5 and Formula 6, scale and zero_point may be calculated by referring to Formula 4 and Formula 5.

For example, the above-mentioned average minimum avg_min and minimum of absolute maximum absmax_min obtained statistically as well as a first search parameter s₁ selected in the first search space S₁ are substituted into the above Formula 5, to calculate the minimum scale_min of the quantization scale factor. The above-mentioned average maximum avg_max and maximum of absolute maximum absmax_max obtained statistically as well as a second search parameter s₂ selected in the second search space s₂ are substituted into the above Formula 6, to calculate the maximum scale_max of the quantization scale factor. scale_min and scale_max are substituted into the Formula 3 for the candidate value of the first quantization parameter, to obtain the candidate value scale of the first quantization parameter. Then, scale_min and scale are substituted into the Formula 4 for the candidate value of the second quantization parameter, to obtain the candidate value zero_point of the second quantization parameter.

In the embodiment of the present disclosure, the candidate values of the quantization parameters calculated based on multiple statistical values of the quantization parameters are more accurate. Using different search parameters can improve the accuracy of the search result.

In one implementation, the loss function is determined based on a quantization function and a dequantization function.

In one implementation, the quantization function is used to perform a rounding operation on the key value matrix in the first format of the benchmark data based on the target value of the first quantization parameter and the target value of the second quantization parameter, to obtain a quantized key value matrix in the second format.

An example of the quantization function is as follows:

$$Q : quant\_x = int ( clip ( \frac{x}{scale} ) + zero\_point , - 8 , 7 ) \qquad Formula 7$$

Here, Q represents the quantization function, quant_x represents a key value matrix in the second format after quantizing a piece of benchmark data x, and int( ) represents the conversion of the data in the brackets into 4-bit integer data. The explanations of clip( ) scale, zero_point and other parameters are similar to those above, may refer to the relevant description above, and will not be repeated here.

In one implementation, the dequantization function is used to perform a floating-point operation on the quantized key value matrix in the second format based on the target value of the first quantization parameter and the target value of the second quantization parameter, to obtain a dequantized key value matrix in the first format.

An example of the dequantization function is as follows:

$$DQ : dequant\_quant \_x = bfloat 16 ( ( quant\_x - zero\_point ) * scale ) \qquad Formula 8$$

Here, DQ represents the dequantization function, dequant_quant_x represents the dequantization of the quantized key value matrix in the second format into the benchmark data x, and bfloat16( ) represents the conversion of the format of the data in the brackets into data of 16-bit brain floating point. In addition, the explanations of scale, zero_point, quant_x and other parameters are similar to those above, may refer to the relevant description above, and will not be repeated here.

An example of the formula of the loss function is as follows:

$$s = {min}_{∀ s ∈ S} Loss ( {QDQ}^{s} ( x ) , x ) where S = [ 0 , 0.1 , 0.2 , 0.3 , 0.4 , 0.5 , 0.6 , 0.7 , 0.8 , 0.9 , 1. ] \qquad Formula 9$$

Here, x represents a tensor corresponding to a piece of benchmark data (for example, input text), Q can refer to Formula 7, and DQ can refer to Formula 8. For K and V in each transformer, an optimal configuration s is adaptively searched from the parameter space S to minimize the loss of KV before and after INT4 quantization. Different models will modify S based on the posterior information. The loss value is calculated using the Mean Square Error loss function (MSE Loss) or top K loss function (topK loss).

For example, the candidate value of the first quantization factor and the candidate value of the second quantization factor calculated by Formula 3 and Formula 4 as well as the current benchmark data x are substituted into the above Formula 7, to quantize the key value matrix quant_x in the second format of the current benchmark data x; and the candidate value of the first quantization factor and the candidate value of the second quantization factor calculated by Formula 3 and Formula 4 as well as the current key value matrix quant_x in the second format are substituted into the above Formula 8, to quantize the current benchmark data dequant_quant_x in the first format. The above quant_x and dequant_quant_x are substituted into Formula 9 of the loss function to obtain the loss value under the current search parameter, and an optimal configuration s is adaptively searched to minimize the loss value, and obtain the search parameter corresponding to the minimum loss value and the target values of the corresponding first quantization factor and second quantization factor.

According to an embodiment of the present disclosure, the loss function may be constructed based on a multiplication result of the quantization function and the dequantization function. The obtained loss function is more consistent with the actual situation of information loss in quantization and dequantization of the benchmark data performed by the quantization scale factor and quantization zero point under the current search parameter. According to the loss function, the quantization scale factor and quantization zero point that are most suitable for quantizing and dequantizing the current benchmark data can be obtained, improving the accuracy of model inference while reducing the occupancy of the memory (such as video memory) by model inference.

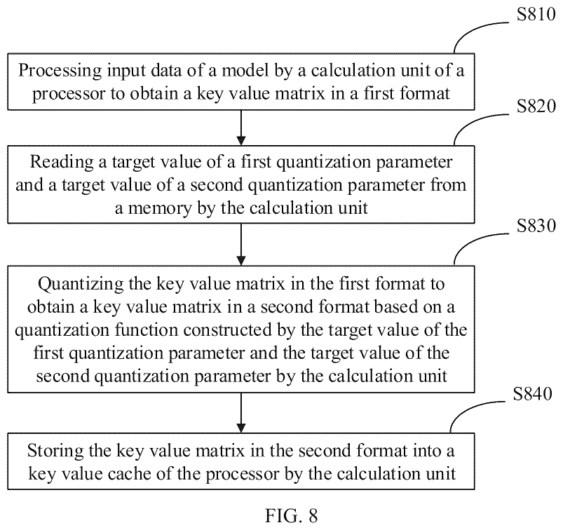

FIG. 8 is a schematic flow chart of a model inference method according to an embodiment of the present disclosure. The method may include:
S810: processing input data of a model by a calculation unit of a processor to obtain a key value matrix in a first format;
S820: reading a target value of a first quantization parameter and a target value of a second quantization parameter from a memory by the calculation unit, where the target value of the first quantization parameter and the target value of the second quantization parameter are stored into the memory before a model inference process by using any embodiment of the quantization parameter storage method described above;
S830: quantizing the key value matrix in the first format to obtain a key value matrix in a second format based on a quantization function constructed by the target value of the first quantization parameter and the target value of the second quantization parameter by the calculation unit; and
S840: storing the key value matrix in the second format into a key value cache of the processor by the calculation unit.

In the embodiment of the present disclosure, the processor may be a Graphics Processing Unit (GPU), a Central Processing Unit (CPU), or a Neural Processing Unit (NPU) (or called a neural network processing unit), etc. The processor may include a calculation unit, a memory, a cache, etc. For example, the calculation unit in the GPU may include a Stream Multiprocessor (SM), and the memory may also be referred to as video memory. The memory may be a hard disk, such as a Solid State Disk (SSD), a Hard Disk Drive (HDD), etc.

In the embodiment of the present disclosure, the processor may perform feature extraction on the input data such as text of the model to obtain the feature data, and the format of the feature data is a key value matrix in the first format, such as BF16. According to the current feature data in BF16, the target value of the corresponding first quantization parameter and the target value of the corresponding second quantization parameter may be read in the memory. The target value of the first quantization parameter and the target value of the second quantization parameter may be quantization parameters that are obtained in advance by calculating the benchmark data using the above-mentioned quantization parameter storage method and stored in the memory before model inference (or model deployment stage). Here, the benchmark data may be data selected from the sample data.

In the embodiment of the present disclosure, the key value cache (KV cache) may be stored in the memory of the processor, and the key value matrix in the first format may be quantized based on the target value of the first quantization parameter and the target value of the second quantization parameter that are read to obtain the key value matrix in the second format such as int4. The key value matrix in the second format has a smaller amount of data than the key value matrix in the first format. The key value matrix in the second format obtained by quantization may be stored in the key value cache in the memory (video memory) of the processor such as GPU.

According to the embodiment of the present disclosure, the benchmark model to be processed by the model can be quantized into the key value matrix in the second format such as int4 with a smaller amount of data for storage in the memory of the calculation unit. Compared with the storage of the key value matrix in the first format such as BF16, the storage space required is smaller, and the consumption of memory resources can be saved. More users can be supported with the same memory resources. The quantization efficiency and applicability are improved by reading the quantization parameters obtained in advance and stored statically from the memory for quantization, compared with real-time calculation of the quantization parameters.

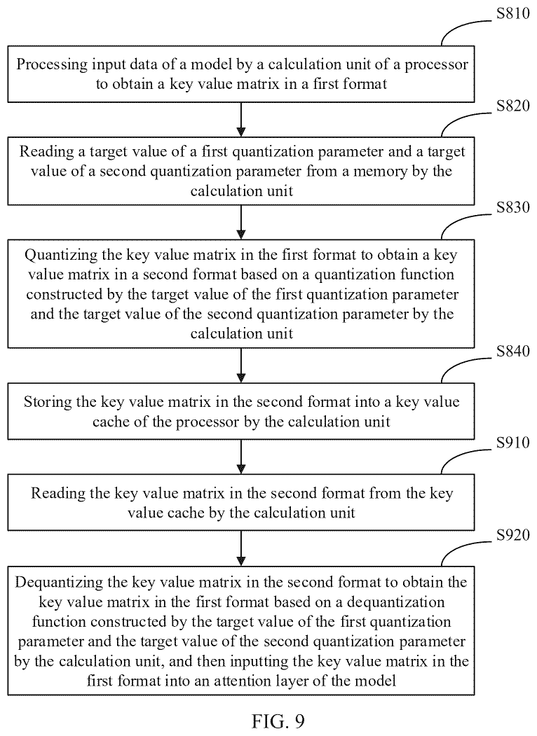

FIG. 9 is a schematic flow chart of a model inference method according to another embodiment of the present disclosure. This embodiment may include one or more features of the above-described embodiments. In one implementation, this method may further include:
S910: reading the key value matrix in the second format from the key value cache by the calculation unit; and
S920: dequantizing the key value matrix in the second format to obtain the key value matrix in the first format based on a dequantization function constructed by the target value of the first quantization parameter and the target value of the second quantization parameter by the calculation unit, and then inputting the key value matrix in the first format into an attention layer of the model.

In the embodiment of the present disclosure, when the attention layer of the model needs the input data for inference, the key value matrix in the second format may be firstly extracted from the key value cache in the memory, and the target value of the corresponding first quantization parameter and the target value of the corresponding second quantization parameter are used for dequantization to obtain the key value matrix in the first format. The key value matrix in the first format is then input into the attention layer of the model for inference.

According to the embodiment of the present disclosure, the key value matrix in the second format in the key value cache can be extracted and dequantized into the key value matrix in the first format before quantization, which not only reduces the occupation of the memory by the key value cache, but also improves the accuracy of model inference.

In one implementation, the quantization function is used to perform a rounding operation on the key value matrix in the first format based on the target value of the first quantization parameter and the target value of the second quantization parameter, to obtain a quantized key value matrix in the second format.

In one implementation, the dequantization function is used to perform a floating-point operation on the key value matrix in the second format based on the target value of the first quantization parameter and the target value of the second quantization parameter, to obtain a dequantized key value matrix in the first format.

In the embodiment of the present disclosure, the data in the first format may be the data required to be input into the model attention layer for inference, and is the data required for model inference; and the data in the second format may be the data stored in the memory of the calculation unit, the data in the second format may be obtained based on the data in the first format, and the data in the second format occupies less memory resources than the data in the first format.

In the embodiment of the present disclosure, when the memory of the calculation unit is required to store the key value matrix, the model in the first format may be quantized into the data in the second format based on the quantization method, and the basis for quantization may be the target value of the first quantization parameter and the target value of the second quantization parameter. When the model is required for inference, the data in the second format may be dequantized into the data in the first format, and the basis for dequantization may be the target value of the first quantization parameter and the target value of the second quantization parameter used when quantizing the data in the first format.

According to the embodiment of the present disclosure, the data in the second format that occupies less memory resources may be stored in the memory of the calculation unit, and the data in the second format is read from the memory and dequantized into the data in the first format for input into the attention layer of the model during model inference, which not only reduces the occupation of the memory by the key value cache, but also improves the accuracy of model inference.

The model inference method in the embodiment of the present disclosure may include a static 4-bit KV cache quantization scheme for large model inference, to reduce the video memory overhead during inference and improve the inference speed. For example, the video memory overhead of 400 GB may be reduced to 100 GB by reducing the KV Cache from 16 bits to 4 bits. Under the premise of the same GPU resource consumption, the model may be optimized from supporting one user to supporting four users at the same time with the same number of resources, increasing the Queries-Per-Second (QPS) by 3 times. The application of this scheme to large model inference optimization scenarios can not only make the use effect of the large model close to lossless, but also reduce the video memory overhead for inference, improve the QPS, and reduce the inference deployment cost of the large model.

In one application scenario, K and V in the model may be stored in the data type of 4-bit integer (INT4) instead of Brain Floating Point 16 (BF16), to speed up the memory access process of K and V, reduce the memory occupancy of inference (−75%), greatly improve the QPS of the large model, and save the inference deployment cost. In order to achieve efficient and accurate the INT4 storage goal, an Adaptive Bagging Quantization (ABQ) algorithm may be used, including, for example, two rounds of calibration:

Round 1: the calibration data (which may be extracted from the training sample) is counted according to the quantization method of average avg and absolute maximum absmax, and the minimum of the quantization scale factor scale_min and the maximum of the quantization scale factor scale_max are calculated.

Round 2: the quantization scale factor (scale) of K and V in each layer that minimizes the value of the loss function (Loss) is searched in the custom search space, and the corresponding quantization zero_point is calculated.

In one implementation, the same s may be shared for scale_min and scale_max in one calculation. In another implementation, different s may be used for scale_min and scale_max in one calculation.

In the case of multiple pieces of data, one or more of operations of calculating the mean value (mean), minimum (min) and maximum (max) may be performed on Loss of different samples under the same K or V, to select scale and zero_point with the best effect.

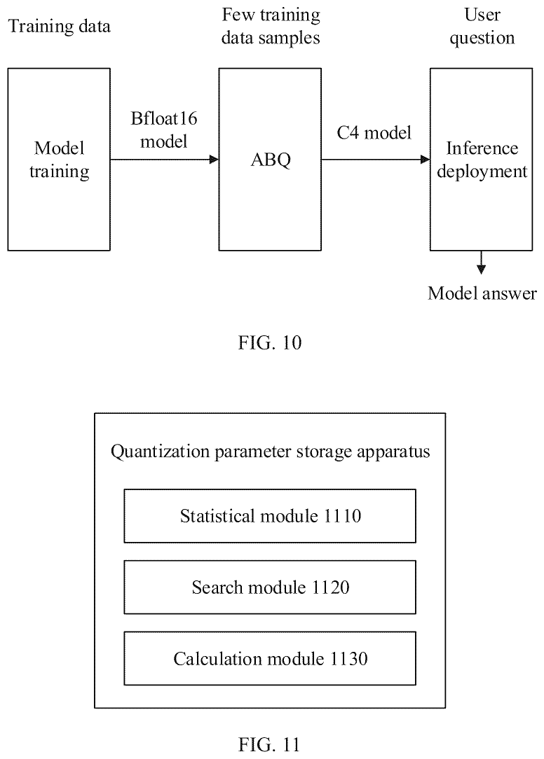

The embodiment of the present disclosure can be widely used in the field of large model inference deployment, such as general model acceleration, long text model deployment, etc., to reduce the inference cost and significantly improve the QPS. One application scenario is shown in FIG. 10. Here, the up and down arrow represents the data flow, and the left and right arrows represent the model flow. When the model is trained, the model receives the training data and produces an original model in the BF16 (bfloat16) data type. The inference deployment cost of this model is high. After the ABQ process, the data type of the KV cache of the model changes from BF16 to INT4. During inference, the C4 model produced by ABQ may be repeatedly invoked to feed back answers to questions of users.

The static C4 quantization scheme (including the ABQ process) in the embodiment of the present disclosure achieves C4 quantization without introducing additional inference overhead (such as time consumption), saves the occupancy of the video memory, improves the QPS, and reduces the inference cost, for example, to 25% of the original cost. In large model products, the C4 quantization scheme is an important acceleration method, and saves the cost by more than 2 times without affecting the user experience. Considering that large models have a huge number of users, this scheme has a huge cost saving space and thus effectively supports low-cost applications of the large models.

FIG. 11 is a structural schematic diagram of a quantization parameter storage apparatus according to an embodiment of the present disclosure. In one implementation, the apparatus may include:
a statistical module 1110 configured to obtain, by a calculation unit of a processor, a statistical value of a first quantization parameter of a model statistically based on benchmark data;
a search module 1120 configured to search for, by the calculation unit, a target value of the first quantization parameter and a target value of a second quantization parameter of the model in a search space based on the statistical value of the first quantization parameter; and a calculation module 1130 configured to store, by the calculation unit, the target value of the first quantization parameter and the target value of the second quantization parameter into a memory.

In one implementation, the target value of the first quantization parameter and the target value of the second quantization parameter can be read from the memory to the processor during model inference, and used to quantize a key value matrix in a first format required by an attention layer of the model into a key value matrix in a second format; where the key value matrix in the second format is stored in a key value cache of the processor.

In one implementation, the target value of the first quantization parameter and the target value of the second quantization parameter can be read from the memory to the processor during model inference, and used to dequantize the key value matrix in the second format read from the key value cache into the key value matrix in the first format; where the dequantized key value matrix is used as an input feature of the attention layer.

In one implementation, the statistics module 1110 is further configured to perform at least one of:
obtaining an average minimum and an average maximum of the first quantization parameter in accordance with average statistics for the benchmark data; and
obtaining a minimum and a maximum of an absolute maximum of the first quantization parameter in accordance with absolute maximum statistics for the benchmark data.

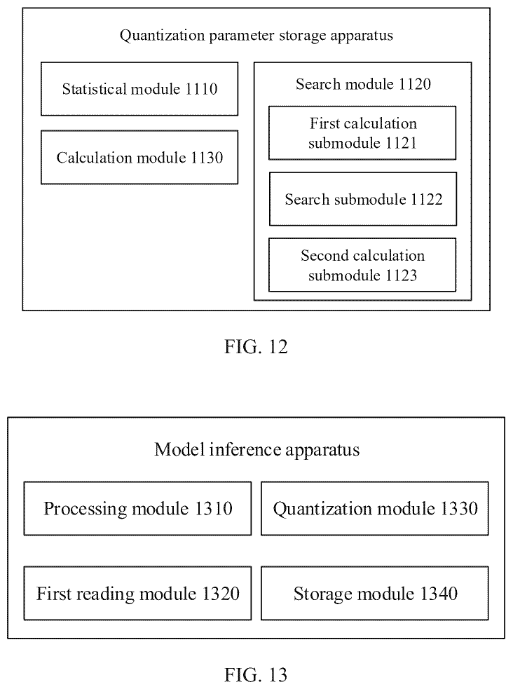

FIG. 12 is a structural schematic diagram of a quantization parameter storage apparatus according to another embodiment of the present disclosure. This apparatus may include one or more features of the quantization parameter storage apparatus described above. In one implementation, the search module 1120 includes:
a first calculation submodule 1121 configured to calculate a candidate value of the first quantization parameter and a candidate value of the second quantization parameter based on the average minimum, the minimum of the absolute maximum, the average maximum, the maximum of the absolute maximum and a search parameter in the search space;
a search submodule 1122 configured to calculate a value of a loss function respectively based on candidate values of the first quantization parameter and candidate values of the second quantization parameter corresponding to all search parameters in the search space and a key value matrix of the benchmark data, to search for a target search parameter that minimizes the value of the loss function; and a second calculation submodule 1123 configured to calculate the target value of the first quantization parameter and the target value of the second quantization parameter based on the target search parameter.

In one implementation, the first calculation submodule 1121 is further configured to:
calculate a minimum of the first quantization parameter based on the average minimum, the minimum of the absolute maximum, and the search parameter in the search space;
calculate a maximum of the first quantization parameter based on the average maximum, the maximum of the absolute maximum, and the search parameter in the search space;
calculate the candidate value of the first quantization parameter based on the maximum and the minimum of the first quantization parameter; and
calculate the candidate value of the second quantization parameter based on the minimum of the first quantization parameter and the candidate value of the first quantization parameter.

In one implementation, the first calculation submodule 1121 is further configured to: calculate a minimum of the first quantization parameter based on the average minimum, the minimum of the absolute maximum, and a first search parameter in a first search space; calculate a maximum of the first quantization parameter based on the average maximum, the maximum of the absolute maximum, and a second search parameter in a second search space; calculate the candidate value of the first quantization parameter based on the maximum and the minimum of the first quantization parameter; and calculate the candidate value of the second quantization parameter based on the minimum of the first quantization parameter and the candidate value of the first quantization parameter.

In one implementation, the loss function is determined based on a quantization function and a dequantization function;
the quantization function is used to perform a rounding operation on the key value matrix in the first format of the benchmark data based on the target value of the first quantization parameter and the target value of the second quantization parameter, to obtain a quantized key value matrix in the second format; and the dequantization function is used to perform a floating-point operation on the quantized key value matrix in the second format based on the target value of the first quantization parameter and the target value of the second quantization parameter, to obtain a dequantized key value matrix in the first format.

FIG. 13 is a structural schematic diagram of a model inference apparatus according to an embodiment of the present disclosure. In one implementation, the apparatus may include:
a processing module 1310 configured to process, by a calculation unit of a processor, input data of a model to obtain a key value matrix in a first format;
a first reading module 1320 configured to read, by the calculation unit, a target value of a first quantization parameter and a target value of a second quantization parameter from a memory, where the target value of the first quantization parameter and the target value of the second quantization parameter are stored into the memory before a model inference process by using any one of the embodiments of the quantization parameter storage apparatus described above;
a quantization module 1330 configured to quantize, by the calculation unit, the key value matrix in the first format to obtain a key value matrix in a second format based on a quantization function constructed by the target value of the first quantization parameter and the target value of the second quantization parameter; and a storage module 1340 configured to store, by the calculation unit, the key value matrix in the second format into a key value cache of the processor.

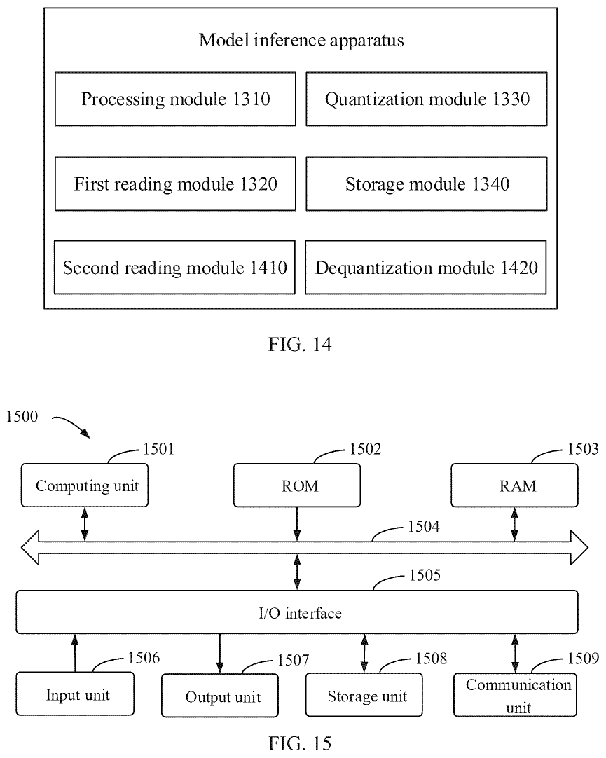

FIG. 14 is a structural schematic diagram of a model inference apparatus according to another embodiment of the present disclosure. This apparatus may include one or more features of the model inference apparatus described above. In one embodiment, this apparatus further includes:
a second reading module 1410 configured to read, by the calculation unit, the key value matrix in the second format from the key value cache; and
a dequantization module 1420 configured to dequantize, by the calculation unit, the key value matrix in the second format to obtain the key value matrix in the first format based on a dequantization function constructed by the target value of the first quantization parameter and the target value of the second quantization parameter, and then input the key value matrix in the first format into an attention layer of the model.

In one implementation, the quantization function is used to perform a rounding operation on the key value matrix in the first format based on the target value of the first quantization parameter and the target value of the second quantization parameter, to obtain a quantized key value matrix in the second format; and the dequantization function is used to perform a floating-point operation on the key value matrix in the second format based on the target value of the first quantization parameter and the target value of the second quantization parameter, to obtain a dequantized key value matrix in the first format.

For the description of specific functions and examples of the modules and sub-modules of the apparatus of the embodiment of the present disclosure, reference may be made to the relevant description of the corresponding steps in the above-mentioned method embodiments, and details are not repeated here.

In the technical solution of the present disclosure, the acquisition, storage and application of the user's personal information involved are in compliance with relevant laws and regulations, and do not violate public order and good customs.

According to the embodiments of the present disclosure, the present disclosure also provides an electronic device, a readable storage medium and a computer program product.

FIG. 15 shows a schematic block diagram of an exemplary electronic device 1500 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 15, the device 1500 includes a computing unit 1501 that may perform various appropriate actions and processes according to a computer program stored in a Read-Only Memory (ROM) 1502 or a computer program loaded from a storage unit 1508 into a Random Access Memory (RAM) 1503. Various programs and data required for an operation of device 1500 may also be stored in the RAM 1503. The computing unit 1501, the ROM 1502 and the RAM 1503 are connected to each other through a bus 1504. The input/output (I/O) interface 1505 is also connected to the bus 1504.

A plurality of components in the device 1500 are connected to the I/O interface 1505, and include an input unit 1506 such as a keyboard, a mouse, or the like; an output unit 1507 such as various types of displays, speakers, or the like; the storage unit 1508 such as a magnetic disk, an optical disk, or the like; and a communication unit 1509 such as a network card, a modem, a wireless communication transceiver, or the like. The communication unit 1509 allows the device 1500 to exchange information/data with other devices through a computer network such as the Internet and/or various telecommunication networks.

The computing unit 1501 may be various general-purpose and/or special-purpose processing components with processing and computing capabilities. Some examples of the computing unit 1501 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1501 performs various methods and processing described above, such as the quantization parameter storage method and/or the model inference method. For example, in some implementations, the quantization parameter storage method and/or the model inference method may be implemented as a computer software program tangibly contained in a computer-readable medium, such as the storage unit 1508. In some implementations, a part or all of the computer program may be loaded and/or installed on the device 1500 via the ROM 1502 and/or the communication unit 1509. When the computer program is loaded into the RAM 1503 and executed by the computing unit 1501, one or more steps of the quantization parameter storage method and/or the model inference method described above may be performed. Alternatively, in other implementations, the computing unit 1501 may be configured to perform the quantization parameter storage method and/or the model inference method by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A quantization parameter storage method, comprising:
obtaining, by a calculation unit of a processor, a statistical value of a first quantization parameter of a model statistically based on benchmark data;
searching for, by the calculation unit, a target value of the first quantization parameter and a target value of a second quantization parameter of the model in a search space based on the statistical value of the first quantization parameter; and
storing, by the calculation unit, the target value of the first quantization parameter and the target value of the second quantization parameter into a memory.

2. The method of claim 1, wherein the target value of the first quantization parameter and the target value of the second quantization parameter can be read from the memory to the processor during model inference, and used to quantize a key value matrix in a first format required by an attention layer of the model into a key value matrix in a second format; wherein the key value matrix in the second format is stored in a key value cache of the processor.

3. The method of claim 2, wherein the target value of the first quantization parameter and the target value of the second quantization parameter can be read from the memory to the processor during model inference, and used to dequantize the key value matrix in the second format read from the key value cache into the key value matrix in the first format; wherein the dequantized key value matrix is used as an input feature of the attention layer.

4. The method of claim 1, wherein obtaining, by a calculation unit of a processor, a statistical value of a first quantization parameter of a model statistically based on benchmark data, comprises at least one of:
obtaining an average minimum and an average maximum of the first quantization parameter in accordance with average statistics for the benchmark data; and
obtaining a minimum and a maximum of an absolute maximum of the first quantization parameter in accordance with absolute maximum statistics for the benchmark data.

5. The method of claim 4, wherein searching for a target value of the first quantization parameter and a target value of a second quantization parameter of the model in a search space based on the statistical value of the first quantization parameter, comprises:
calculating a candidate value of the first quantization parameter and a candidate value of the second quantization parameter based on the average minimum, the minimum of the absolute maximum, the average maximum, the maximum of the absolute maximum and a search parameter in the search space;
calculating a value of a loss function respectively based on candidate values of the first quantization parameter and candidate values of the second quantization parameter corresponding to all search parameters in the search space and a key value matrix of the benchmark data, to search for a target search parameter that minimizes the value of the loss function; and
calculating the target value of the first quantization parameter and the target value of the second quantization parameter based on the target search parameter.

6. The method of claim 5, wherein calculating a candidate value of the first quantization parameter and a candidate value of the second quantization parameter based on the average minimum, the minimum of the absolute maximum, the average maximum, the maximum of the absolute maximum and a search parameter in the search space, comprises:
calculating a minimum of the first quantization parameter based on the average minimum, the minimum of the absolute maximum, and the search parameter in the search space;
calculating a maximum of the first quantization parameter based on the average maximum, the maximum of the absolute maximum, and the search parameter in the search space;
calculating the candidate value of the first quantization parameter based on the maximum and the minimum of the first quantization parameter; and
calculating the candidate value of the second quantization parameter based on the minimum of the first quantization parameter and the candidate value of the first quantization parameter.

7. The method of claim 5, wherein calculating a candidate value of the first quantization parameter and a candidate value of the second quantization parameter based on the average minimum, the minimum of the absolute maximum, the average maximum, the maximum of the absolute maximum and a search parameter in the search space, comprises:
calculating a minimum of the first quantization parameter based on the average minimum, the minimum of the absolute maximum, and a first search parameter in a first search space;
calculating a maximum of the first quantization parameter based on the average maximum, the maximum of the absolute maximum, and a second search parameter in a second search space;
calculating the candidate value of the first quantization parameter based on the maximum and the minimum of the first quantization parameter; and
calculating the candidate value of the second quantization parameter based on the minimum of the first quantization parameter and the candidate value of the first quantization parameter.

8. The method of claim 5, wherein the loss function is determined based on a quantization function and a dequantization function;
the quantization function is used to perform a rounding operation on the key value matrix in the first format of the benchmark data based on the target value of the first quantization parameter and the target value of the second quantization parameter, to obtain a quantized key value matrix in the second format; and
the dequantization function is used to perform a floating-point operation on the quantized key value matrix in the second format based on the target value of the first quantization parameter and the target value of the second quantization parameter, to obtain a dequantized key value matrix in the first format.

9. A model inference method, comprising:
processing, by a calculation unit of a processor, input data of a model to obtain a key value matrix in a first format;
reading, by the calculation unit, a target value of a first quantization parameter and a target value of a second quantization parameter from a memory, wherein the target value of the first quantization parameter and the target value of the second quantization parameter are stored into the memory before a model inference process by using the method of claim 1;
quantizing, by the calculation unit, the key value matrix in the first format to obtain a key value matrix in a second format based on a quantization function constructed by the target value of the first quantization parameter and the target value of the second quantization parameter; and
storing, by the calculation unit, the key value matrix in the second format into a key value cache of the processor.

10. The method of claim 9, further comprising:
reading, by the calculation unit, the key value matrix in the second format from the key value cache; and
dequantizing, by the calculation unit, the key value matrix in the second format to obtain the key value matrix in the first format based on a dequantization function constructed by the target value of the first quantization parameter and the target value of the second quantization parameter, and then inputting the key value matrix in the first format into an attention layer of the model.

11. The method of claim 10, wherein the quantization function is used to perform a rounding operation on the key value matrix in the first format based on the target value of the first quantization parameter and the target value of the second quantization parameter, to obtain a quantized key value matrix in the second format; and
the dequantization function is used to perform a floating-point operation on the key value matrix in the second format based on the target value of the first quantization parameter and the target value of the second quantization parameter, to obtain a dequantized key value matrix in the first format.

12. An electronic device, comprising:
at least one processor; and
a memory connected in communication with the at least one processor;
wherein the memory stores an instruction executable by the at least one processor, and the instruction, when executed by the at least one processor, enables the at least one processor to execute:
obtaining, by a calculation unit of a processor, a statistical value of a first quantization parameter of a model statistically based on benchmark data;
searching for, by the calculation unit, a target value of the first quantization parameter and a target value of a second quantization parameter of the model in a search space based on the statistical value of the first quantization parameter; and
storing, by the calculation unit, the target value of the first quantization parameter and the target value of the second quantization parameter into a memory.

13. The electronic device of claim 12, wherein the target value of the first quantization parameter and the target value of the second quantization parameter can be read from the memory to the processor during model inference, and used to quantize a key value matrix in a first format required by an attention layer of the model into a key value matrix in a second format; wherein the key value matrix in the second format is stored in a key value cache of the processor.

14. The electronic device of claim 13, wherein the target value of the first quantization parameter and the target value of the second quantization parameter can be read from the memory to the processor during model inference, and used to dequantize the key value matrix in the second format read from the key value cache into the key value matrix in the first format; wherein the dequantized key value matrix is used as an input feature of the attention layer.

15. The electronic device of claim 12, wherein obtaining, by a calculation unit of a processor, a statistical value of a first quantization parameter of a model statistically based on benchmark data, comprises at least one of:
obtaining an average minimum and an average maximum of the first quantization parameter in accordance with average statistics for the benchmark data; and
obtaining a minimum and a maximum of an absolute maximum of the first quantization parameter in accordance with absolute maximum statistics for the benchmark data.

16. An electronic device, comprising:
at least one processor; and
a memory connected in communication with the at least one processor;
wherein the memory stores an instruction executable by the at least one processor, and the instruction, when executed by the at least one processor, enables the at least one processor to execute the method of claim 9.

17. A non-transitory computer-readable storage medium storing a computer instruction thereon, wherein the computer instruction is used to cause a computer to execute:
obtaining, by a calculation unit of a processor, a statistical value of a first quantization parameter of a model statistically based on benchmark data;
searching for, by the calculation unit, a target value of the first quantization parameter and a target value of a second quantization parameter of the model in a search space based on the statistical value of the first quantization parameter; and
storing, by the calculation unit, the target value of the first quantization parameter and the target value of the second quantization parameter into a memory.

18. The non-transitory computer-readable storage medium of claim 17, wherein the target value of the first quantization parameter and the target value of the second quantization parameter can be read from the memory to the processor during model inference, and used to quantize a key value matrix in a first format required by an attention layer of the model into a key value matrix in a second format; wherein the key value matrix in the second format is stored in a key value cache of the processor.

19. The non-transitory computer-readable storage medium of claim 18, wherein the target value of the first quantization parameter and the target value of the second quantization parameter can be read from the memory to the processor during model inference, and used to dequantize the key value matrix in the second format read from the key value cache into the key value matrix in the first format; wherein the dequantized key value matrix is used as an input feature of the attention layer.

20. A non-transitory computer-readable storage medium storing a computer instruction thereon, wherein the computer instruction is used to cause a computer to execute the method of claim 9.
